(19) United States
(12) Patent Application Publication
(10) Pub. No.: US 2025/0193623 A1
(43) Pub. Date: Jun. 12, 2025

(54) PROXIMITY-BASED AUDIO PANNING OF A VIRTUAL SOUND SOURCE

(71) Applicant: HARMAN INTERNATIONAL INDUSTRIES, INCORPORATED, Stamford, CT (US)

(72) Inventors: Christopher Michael TRESTAIN, Livonia, MI (US); Kevin J. BASTYR, Franklin, MI (US); Jason RIGGS, Northridge, CA (US)

(21) Appl. No.: 18/967,903

(22) Filed: Dec. 4, 2024

Related U.S. Application Data
(60) Provisional application No. 63/607,819, filed on Dec. 8, 2023.

(51) Int. Cl. H04S 7/00; A63H 5/00

(52) U.S. Cl. CPC H04S 7/302; A63H 5/00; A63H 2200/00; H04S 2400/11; H04S 2400/13

(57) ABSTRACT

Techniques for audio panning of a virtual sound source are described. In some embodiments, the techniques include determining a first distance between a first speaker and a virtual sound source; determining a second distance between a second speaker and the virtual sound source; generating a first audio output signal for the first speaker based on an input audio signal, the first distance, and the second distance; generating a second audio output signal for the second speaker based on the input audio signal, the first distance, and the second distance; transmitting the first audio output signal to the first speaker for output; and transmitting the second audio output signal to the second speaker for output.

### CROSS-REFERENCE TO RELATED APPLICATIONS

This application claims the benefit of U.S. Provisional patent application titled, “PROXIMITY-BASED AUDIO OBJECT PANNING,” filed on Dec. 8, 2023, and having Ser. No. 63/607,819. The subject matter of this related application is hereby incorporated herein by reference.

### BACKGROUND

### Field of the Various Embodiments

The contemplated embodiments relate generally to audio systems and, more specifically, to proximity-based audio panning of a virtual sound source.

### Description of the Related Art

The use of virtual reality (VR) and augmented reality (AR) in many applications is gaining popularity. VR is an interactive experience that typically supplants the real-world environment of a user simulated via auditory and video feedback, while AR is an interactive experience featuring a combination of real and virtual worlds, real-time interaction, and accurate 3D registration of virtual and real objects. VR and AR are intended to provide a user with an immersive experience of either a virtual world or of the real world augmented with virtual sensory information. VR and AR applications now include entertainment (e.g., video games and multi-media entertainment), education (e.g., medical and military training) and business (e.g., virtual meetings or other interactions).

A significant challenge in VR and AR applications is how to map virtual sound sources to real speakers in a listening area to create an immersive and realistic audio experience. Creating such an accurate spatial audio scene using multiple speakers requires information about where the speakers are in the listening room so that each speaker appropriately processes an input audio signal that simulates the correct physical position of a virtual sound source. Tracking precise locations of speakers can be complicated and requires expensive sensors, such as IR emitters/receivers, UWB emitters/receivers, and/or a game engine-like software system. These approaches significantly increase the cost and complexity of a VR or AR audio system, making these approaches impractical for small-format and low computing-capability products, such as low-cost toys, to generate an immersive audio scene in which the location of the toy or other virtual sound is accurately simulated.

As the foregoing illustrates, what is needed in the art are improved techniques for generating an immersive audio scene.

### SUMMARY

One embodiment of the present disclosure sets forth a computer-implemented method that includes determining a first distance between a first speaker and a virtual sound source; determining a second distance between a second speaker and the virtual sound source; generating a first audio output signal for the first speaker based on an input audio signal, the first distance, and the second distance; generating a second audio output signal for the second speaker based on the input audio signal, the first distance, and the second distance; transmitting the first audio output signal to the first speaker for output; and transmitting the second audio output signal to the second speaker for output.

At least one technical advantage of the disclosed techniques relative to the prior art is that, with the disclosed techniques, a spatial audio scene can be created that includes a virtual sound source, such as a toy or other object for which an audio signal representing the virtual sound source is generated by speakers that are physically separate from the virtual sound source. With the disclosed techniques, the spatial audio scene can be produced using proximity sensors that measure the distance from the virtual sound source to each speaker that generates the audio signal representing the virtual sound source. As a result, the disclosed techniques can produce an immersive spatial audio mix with fewer hardware components and reduced software processing than other immersive spatial audio approaches. Another advantage of the disclosed techniques is that the techniques are flexible with respect to various characteristics of the sound system producing a spatial audio scene, such as the number of speakers included in the sound system, the locations of the speakers within the listening area, and the number and location of virtual sound sources in the spatial audio scene. A further advantage of the disclosed techniques is that the techniques are readily implemented with real-time audio processing, which is important for immersive applications where audio needs to be processed and distributed quickly to maintain a certain audio experience. These technical advantages represent one or more technological improvements over prior art approaches.

### BRIEF DESCRIPTION OF THE DRAWINGS

So that the manner in which the above recited features of the various embodiments can be understood in detail, a more particular description of the inventive concepts, briefly summarized above, may be had by reference to various embodiments, some of which are illustrated in the appended drawings. It is to be noted, however, that the appended drawings illustrate only typical embodiments of the inventive concepts and are therefore not to be considered limiting of scope in any way, and that there are other equally effective embodiments.

FIG. 1 is a schematic diagram illustrating an audio system according to various embodiments;

FIG. 2 is a conceptual diagram of an audio system and a listening area, according to an embodiment;

FIG. 3 is a conceptual diagram of an audio system and a listening area, according to another embodiment;

FIG. 4 illustrates a cross-fader curve for determining gain values, according to various embodiments;

FIGS. 5A-5E illustrate various cross-fader curves for determining gain values, according to other various embodiments; and

FIG. 6 is a flow diagram of method steps for producing a spatial audio scene, according to various embodiments.

### DETAILED DESCRIPTION

In the following description, numerous specific details are set forth to provide a more thorough understanding of the various embodiments. However, it will be apparent to one of skilled in the art that the inventive concepts may be practiced without one or more of these specific details.

### INTRODUCTION

According to various embodiments, a spatial audio scene is produced by an audio system using proximity-base audio-object panning. In the embodiments, the spatial audio scene includes at least one virtual sound source, such as a toy or other object, that operates as a virtual sound source within the spatial audio scene. To produce the spatial audio scene, an audio signal representing the virtual sound source is generated by speakers of the audio system that are physically separate from the virtual sound source and therefore are not contained within the virtual sound source. In the embodiments, the audio signal generated by each speaker varies in volume based on a change in location of the virtual sound source relative to the speakers. As a result, the spatial audio scene provides a user proximate the audio system with an immersive audio experience in which motion of the virtual sound source is reflected by proximity-based audio-object panning. In the embodiments, the spatial audio scene can be produced using proximity sensors that measure a distance from the virtual sound source to each speaker, where a gain value for each speaker is determined based on the measured distance from the virtual sound source to that speaker. Because the gain value for each speaker is based on a measured distances between the virtual sound source and the speakers, a complex two- or three-dimensional map of the relative positions of the speakers and the virtual sound source(s) is not required to produce the spatial audio scene. As a result, the audio system produces an immersive spatial audio mix with fewer hardware components and reduced software processing than other immersive spatial audio approaches.

### System Overview

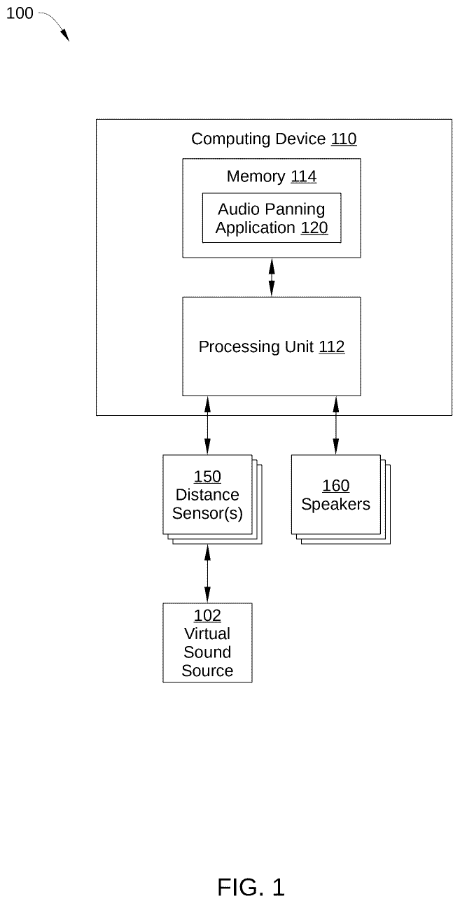

FIG. 1 is a block diagram of an audio system 100 configured to implement one or more embodiments of the present disclosure. As shown, audio system 100 includes, without limitation, a computing device 110, one or more distance sensors 150, a plurality of speakers 160, and a virtual sound source 102. Computing device 110 includes, without limitation, a processing unit 112 and a memory 114. Memory 114 stores, without limitation, an audio panning application 120. Virtual sound source 102 can be an interactive toy or other object for which an audio signal representing virtual sound source 102 is generated by speakers 160. Typically, the audio signal can be a sound effect or other sound that is nominally generated by virtual sound source 102, but is actually generated by speakers 160. As shown, speakers 160 are not disposed within virtual sound source 102 and instead are physically separate from virtual sound source 102.

In operation, when outputting an audio signal corresponding to virtual sound source 102, audio system 100 uses measured distances between virtual sound source 102 corresponding to a physical device (e.g., a toy or other object that may not have audio output capabilities) and each of the plurality of speakers 160 to generate gain settings for each of the plurality of speakers 160. In particular, audio panning application 120 uses distance sensor(s) 150 to determine the distance between virtual sound source 102 and each of speakers 160. Audio panning application 120 then uses the measured distances and one or more gain curves to determine a gain value for each of the plurality of speakers 160. The gain values are then used to control the volume of the audio signal output by each speaker 160 to create sound associated with virtual sound source 102.

Distance sensor(s) 150 include various types of sensors for measuring a distance between virtual sound source 102 and each of speakers 160. In some embodiments, distance sensor(s) 150 are proximity sensors. Distance sensor(s) 150 can use any technically feasible distance measuring techniques including, but not limited to the use of ultrasonics, infrared light, computer imaging modalities, and/or the like. In some embodiments, one or more distance sensors 150 are disposed within virtual sound source 102. For example, in some embodiments, distance sensors 150 include a microphone disposed within virtual sound source 102 that enables detection of inaudible audio signals generated by each speaker 160 to determine a distance between virtual sound source 102 and each speaker. In another example, in some embodiments, distance sensors 150 include an ultrasonic sensor that measures a distance to a speaker 160 by transmitting sound waves toward the speaker 160 and measuring the time interval required for a portion of the transmitted sound waves to be reflected back to the ultrasonic sensor. Additionally or alternatively, in some embodiments, one or more distance sensors 150 are disposed within each speaker 160. Additionally or alternatively, in some embodiments, one or more distance sensors 150 of audio system 100 are physically separate from both virtual sound source 102 and speakers 160.

In some embodiments, the audio system 100 includes other types of sensors in addition to the distance sensor(s) 150 to acquire information about the acoustic environment. Other types of sensors include cameras, a quick response (QR) code tracking system, motion sensors, such as an accelerometer or an inertial measurement unit (IMU) (e.g., a three-axis accelerometer, gyroscopic sensor, and/or magnetometer), pressure sensors, and so forth. In addition, in some embodiments, distance sensor(s) 150 can include wireless sensors, including radio frequency (RF) sensors (e.g., sonar and radar), and/or wireless communications protocols, including Bluetooth, Bluetooth low energy (BLE), cellular protocols, and/or near-field communications (NFC).

Each of the plurality of speakers 160 can be any technically feasible type of audio outputting device. For example, in some embodiments, the plurality of speakers 160 includes one or more digital speakers that receive an audio output signal in a digital form and convert the audio output signals into air-pressure variations or sound energy via a transducing process. According to various embodiments, each of the plurality of speakers 160 generates an audio signal (outputs sound) for virtual sound source 102 at a volume or gain level determined by audio panning application 120.

Computing device 110 enables implementation of the various embodiments described herein. In the embodiment illustrated in FIG. 1, computing device 110 includes processing unit 112 and memory 114.

Processing unit 112 can be any suitable processor, such as a central processing unit (CPU), a graphics processing unit (GPU), an application-specific integrated circuit (ASIC), a field programmable gate array (FPGA), a digital signal processor (DSP), and/or any other type of processing unit, or a combination of different processing units, such as a CPU configured to operate in conjunction with a GPU and/or a DSP. In general, processing unit 112 can be any technically feasible hardware unit capable of processing data and/or executing software applications, such as audio panning application 120.

Memory 114 can include a random-access memory (RAM) module, a flash memory unit, or any other type of memory unit or combination thereof. Processing unit 112 is configured to read data from and write data to the memory 114. In various embodiments, memory 114 includes non-volatile memory, such as optical drives, magnetic drives, flash drives, or other storage. In some embodiments, separate data stores, such as an external data stores included in a network (“cloud storage”) can supplement memory 114. Audio panning application 120 within memory 114 can be executed by processing unit 112 to implement the overall functionality of computing device 110 and, thus, to coordinate the operation of audio system 100 as a whole. In various embodiments, an interconnect bus (not shown) connects processing unit 112, memory 114, speaker(s) 160, distance sensor(s) 150, and any other components of computing device 110.

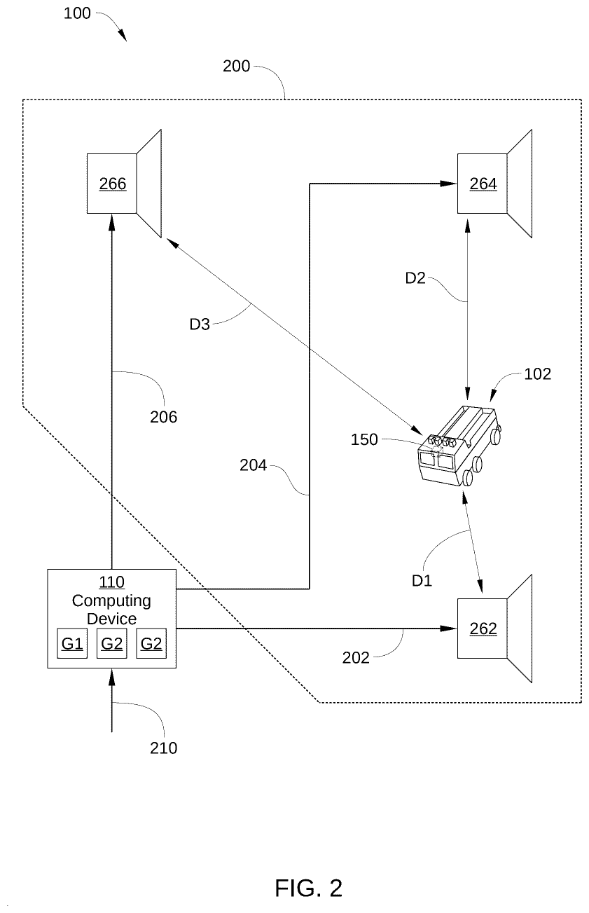

In various embodiments, computing device 110 is included in virtual sound source 102, allowing virtual sound source 102 to use audio panning application 120 to generate a suitable sound level for each speaker 160 that generates an audio output representing virtual sound source 102. Alternatively, in some embodiments, computing device 110 is separate from virtual sound source 102 and distance sensor(s) 150 are disposed within virtual sound source 102. One such embodiment is described below in conjunction with FIG. 2. In such embodiments, computing device 110 can be included in a home theater system, a soundbar, a vehicle system, another computing device (e.g., a desktop, a lap top, a tablet, a mobile device, etc.) and/or the like. Similarly, in such embodiments, computing device 110 can be included in one or more devices that are separate from virtual sound source 102, such as consumer products (e.g., portable speakers, gaming devices, gambling devices, modular toy components, etc.), vehicles (e.g., the head unit of a car, truck, van, etc.), smart home devices (e.g., smart lighting systems, security systems, digital assistants, etc.), communications systems (e.g., conference call systems, video conferencing systems, speaker amplification systems, etc.), and so forth. In various embodiments, virtual sound source 102 and the computing device 110 are located in various environments including, without limitation, indoor environments (e.g., living room, conference room, conference hall, home office, etc.), and/or outdoor environments, (e.g., patio, rooftop, garden, etc.).

FIG. 2 is a conceptual diagram of audio system 100 and a listening area 200, according to an embodiment. As shown, computing device 110 of audio system 100 is separate from virtual sound source 102, while a distance sensor 150 is disposed within virtual sound source 102. For example, computing device 110 can be modular sound unit for an interactive toy system that includes virtual sound source 102, and virtual sound source 102 can be an interactive toy included in the interactive toy system. In such embodiments, virtual sound source 102 can be an interactive toy or other object for which a suitable sound effect or other audio output is generated by speakers 160. In the embodiment illustrated in FIG. 2, audio system 100 includes, without limitation, a first speaker 262, a second speaker 264, and a third speaker 266, each of which can be consistent with speakers 160 of FIG. 1. Further, virtual sound source 102, first speaker 262, second speaker 264, and third speaker 266 are disposed within and/or proximate to a listening area 200 that can be occupied by a user (not shown).

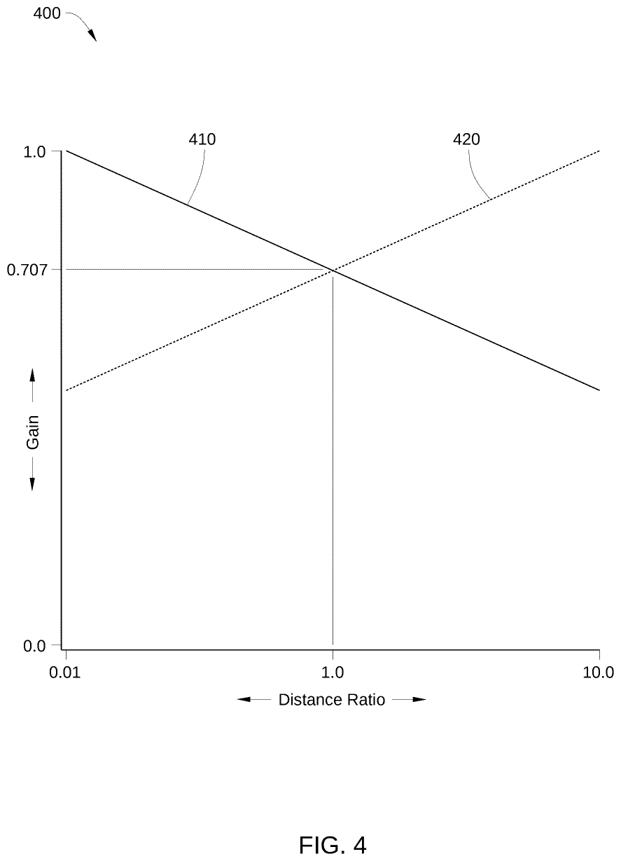

In operation, distance sensor 150 determines a distance D1 between virtual sound source 102 and first speaker 262, a distance D2 between virtual sound source 102 and second speaker 264, and a distance D3 between virtual sound source 102 and third speaker 266. Distance sensor 150 then transmits distances D1, D2, and D3, to computing device 110, so that audio panning application 120 can determine a suitable gain value G1 for first speaker 262, a suitable gain value G2 for second speaker 264, and a suitable gain value G3 for third speaker 266. Techniques for determining gain value G1, gain value G2, and gain value G3 are described below in conjunction with FIG. 4. Once computing device 110 determines gain value G1, gain value G2, and gain value G3, computing device 110 generates a first audio output signal 202 to first speaker 262, a second audio output signal 204 to second speaker 264, and a third audio output signal 206 to third speaker 266. In some embodiments, computing device 110 generates first audio output signal 202, second audio output signal 204, and third audio output signal 206 based on an input audio signal 210 and a particular gain value, where input audio signal 210 represents a sound associated with virtual sound source 102. In such embodiments, computing device 110 generates first audio output signal 202 by modifying input audio signal 210 with gain value G1, second audio output signal 204 by modifying input audio signal 210 with gain value G2, and third audio output signal 206 by modifying input audio signal 210 with gain value G3. Computing device 110 then transmits first audio output signal 202 to first speaker 262, second audio output signal 204 to second speaker 264, and third audio output signal 206 to third speaker 266. First speaker 262 then generates an audio output (not shown) based on first audio output signal 202. Similarly, second speaker 264 generates an audio output (not shown) based on second audio output signal 202 and third speaker 266 generates an audio output (not shown) based on third audio output signal 206. In this way, audio from one or more virtual sound sources (e.g., virtual sound source 102) is distributed to an arbitrary number of physical speakers (e.g., first speaker 262, second speaker 264, and third speaker 266) so that localization of the virtual sound source within listening area 200 is perceptually accurate.

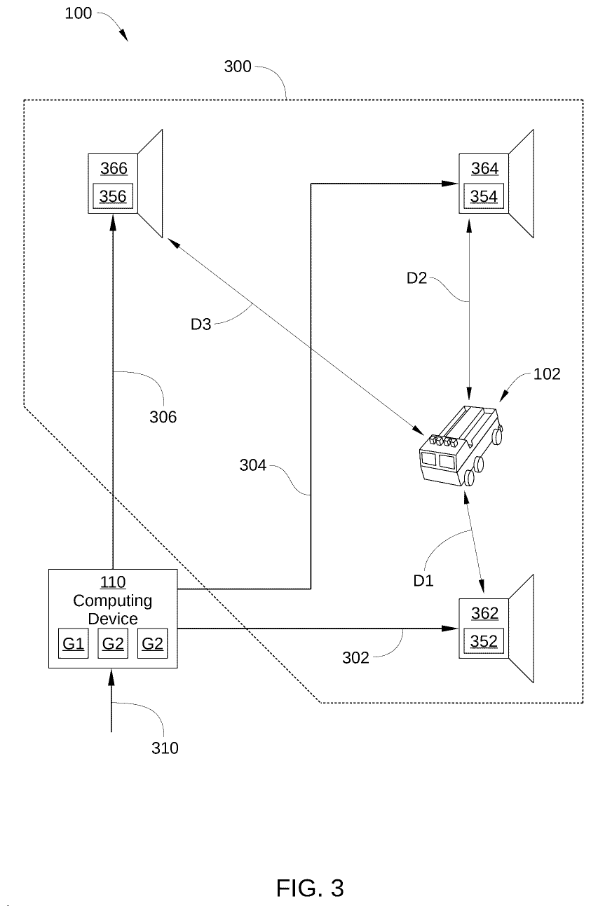

FIG. 3 is a conceptual diagram of audio system 100 and a listening area 300, according to another embodiment. As shown, audio system 100 includes a first speaker 362, a second speaker 364, and a third speaker 366, each of which can be consistent with speakers 160 of FIG. 1. Further, virtual sound source 102, first speaker 362, second speaker 364, and third speaker 366 are disposed within and/or proximate to a listening area 300 that can be occupied by a user (not shown). In contrast to the embodiment of audio system 100 illustrated in FIG. 2, in FIG. 3 a different distance sensor is disposed within each speaker of audio system 100. Thus, a distance sensor 352 is disposed within first speaker 362, a distance sensor 354 is disposed within second speaker 364, and a distance sensor 356 is disposed within third speaker 366.

In operation, distance sensor 352 determines a distance D1 between virtual sound source 102 and first speaker 362, distance sensor 354 determines a distance D2 between virtual sound source 102 and second speaker 364, and distance sensor 356 determines a distance D3 between virtual sound source 102 and third speaker 366. Distance sensor 352 transmits distance D1 to computing device 110, distance sensor 354 transmits distance D2 to computing device 110, and distance sensor 356 transmits distance D3 to computing device 110. Audio panning application 120 can then determine a suitable gain value G1 for first speaker 362 based on distance D1, a suitable gain value G2 for second speaker 364 based on distance D2, and a suitable gain value G3 for third speaker 366 based on distance D3. Once computing device 110 determines gain value G1, gain value G2, and gain value G3, computing device 110 generates a first audio output signal 302 to first speaker 362, a second audio output signal 304 to second speaker 364, and a third audio output signal 306 to third speaker 366. In some embodiments, computing device 110 generates first audio output signal 302, second audio output signal 304, and third audio output signal 306 based on an input audio signal 310 and a particular gain value, where input audio signal 310 represents a sound associated with virtual sound source 102. In such embodiments, computing device 110 generates first audio output signal 302 by modifying input audio signal 310 with gain value G1, second audio output signal 304 by modifying input audio signal 310 with gain value G2, and third audio output signal 306 by modifying input audio signal 310 with gain value G3. Computing device 110 then transmits first audio output signal 302 to first speaker 362, second audio output signal 304 to second speaker 364, and third audio output signal 306 to third speaker 366. First speaker 362 then generates an audio output (not shown) based on first audio output signal 302. Similarly, second speaker 364 generates an audio output (not shown) based on second audio output signal 304, and third speaker 366 generates an audio output (not shown) based on third audio output signal 306. In this way, audio from one or more virtual sound sources (e.g., virtual sound source 102) is distributed to an arbitrary number of physical speakers (e.g., first speaker 362, second speaker 364, and third speaker 366) so that localization of the virtual sound source within listening area 200 is perceptually accurate.

### Procedure for Proximity-Based Audio Object Panning

According to various embodiments, an audio system produces a spatial audio scene using proximity-base audio-object panning. In particular, in an audio system that includes multiple speakers and a virtual sound source, as the virtual sound source is moved away from a first speaker and closer to a second speaker, a gain value by which the first speaker modifies an audio input signal decreases and a gain value by which the second speaker modifies the audio input signal increases. The resultant effect is that the perceived location of the source of sound (sometimes referred to as a “phantom sound image”) moves away from the first speaker and closer to the second speaker, which produces the desired result: the phantom sound image follows the virtual sound source as the virtual sound source moves within a listening area. Thus, as the virtual sound source is moved among and/or around the speakers of the audio system, the audio system generates a different audio output from each speaker, and the perceived location of the virtual sound source matches the physical location of the virtual sound source.

In some embodiments, audio panning application 120 employs a gain computation for determining a gain value for each speaker. In such embodiments, the gain value for each speaker is based on the distance between the virtual sound source and the speaker, where a gain value for a particular speaker is functionally equivalent to a volume knob setting for that particular speaker. In some embodiments, the audio signal representing sound virtually generated by the virtual sound source is assumed to remain approximately constant and each speaker of the audio system is assumed to have approximately equal sensitivity (e.g., change in output volume) to changes in the gain value associated with that speaker. In such embodiments, the sum of the squares of each gain value equals a constant value. Alternatively, when one or more speakers are known to have different sensitivities, an appropriate offset gain value can be applied to one or more speakers to compensate for such a difference in sensitivity to changes in the gain values determined by audio panning application 120.

In some embodiments, the gain computation employed by audio panning application 120 is based on a simple panning algorithm to determine a gain value for each speaker. In such embodiments, the panning algorithm can be represented by a cross-fader curve. For clarity of description, use of a cross-fader curve for determining gain values is described herein with respect to an audio system that includes two speakers (e.g., first speaker 262 and second speaker 264 of FIG. 2) and a single virtual sound source (e.g., virtual sound source 102 of FIG. 2). One embodiment of such a cross-fader curve is described below in conjunction with FIG. 4.

FIG. 4 illustrates a cross-fader curve 400 for determining gain values, according to various embodiments. Cross-fader curve 400 includes a set of two gain curves that vary as a function of the position of virtual sound source 102. Specifically, cross-fader curve 400 includes a first gain curve 410 that represents a set of gain values for a first speaker (e.g., any of speakers 262, 264, 266, 362, 364, or 366) and a second gain curve 420 (dashed lines) that represents a set of gain values for a second speaker (e.g., another of speakers 262, 264, 266, 362, 364, or 366). The left side of cross-fader curve 400 indicates gain values for the first speaker and the second speaker when virtual sound source 102 is closer to the first speaker. Conversely, the right side of cross-fader curve 400 indicates gain values for the first speaker and the second speaker when virtual sound source 102 is closer to the second speaker. Thus, first gain curve 410 has higher values on the left side of cross-fader curve 400 and lower values on the right side of cross-fader curve 400, while second gain curve 420 has higher values on the right side of cross-fader curve 400 and lower values on the left side of cross-fader curve 400.

Gain values for the first speaker and the second speaker are determined with cross-fader curve 400 based on distance D1 (between virtual sound source 102 and the first speaker) and distance D2 (between virtual sound source 102 and the second speaker). In some embodiments, a distance ratio of D1 and D2 is computed and used as an input for first gain curve 410 and second gain curve 420. For example, in the embodiment illustrated in FIG. 4, the distance ratio value on the left side of cross-fader curve 400 is a minimum value (e.g., 0.01), the distance ratio value on the right side of cross-fader curve 400 is a maximum value (e.g., 10), and the distance ratio value in the center of the graph is 1. In addition, in the embodiment illustrated in FIG. 4, possible gain values for the first speaker and the second speaker vary from 0, which occurs at a minimum distance ratio value for the speaker, to 1, which occurs at a maximum distance ratio value for the speaker. Thus, in such an embodiment, when the current position of virtual sound source 102 is halfway between the first speaker and the second speaker, the distance ratio value for the current position of virtual sound source 102 is 1/1, which equals 1.0. As shown, for the embodiment of first gain curve 410 and second gain curve 420 shown in FIG. 4, when the current position of virtual sound source 102 is halfway between the first speaker and the second speaker and the distance ratio value for the current position of virtual sound source 102 is 1, the gain value indicated by first gain curve 410 is 0.707 and the gain value indicated by second gain curve 420 0.707. Thus, in the above-described embodiments, gain values for the first speaker and the second speaker can be determined based on distance D1 and distance D2, and without having a two-dimensional or three-dimensional mapping of the relative locations of the first speaker, the second speaker, and virtual sound source 102 within listening area 200.

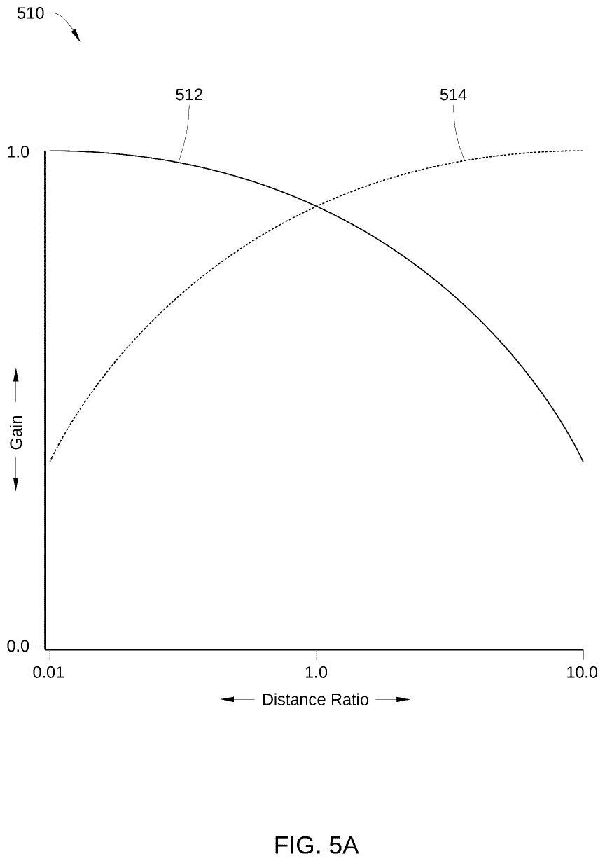

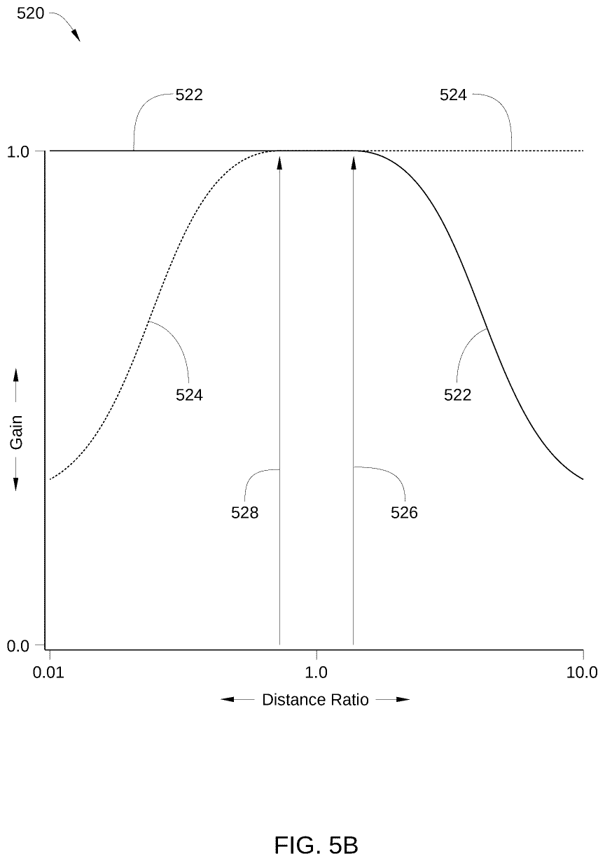

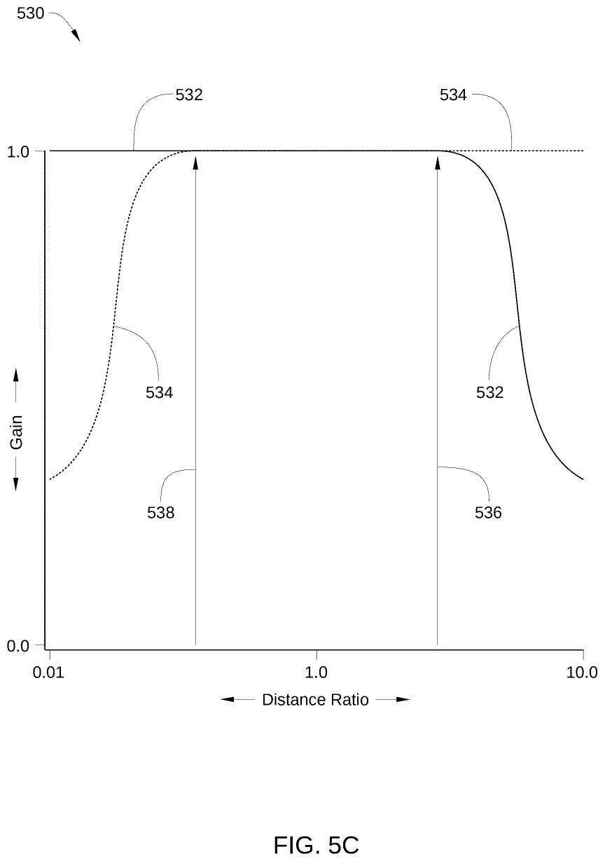

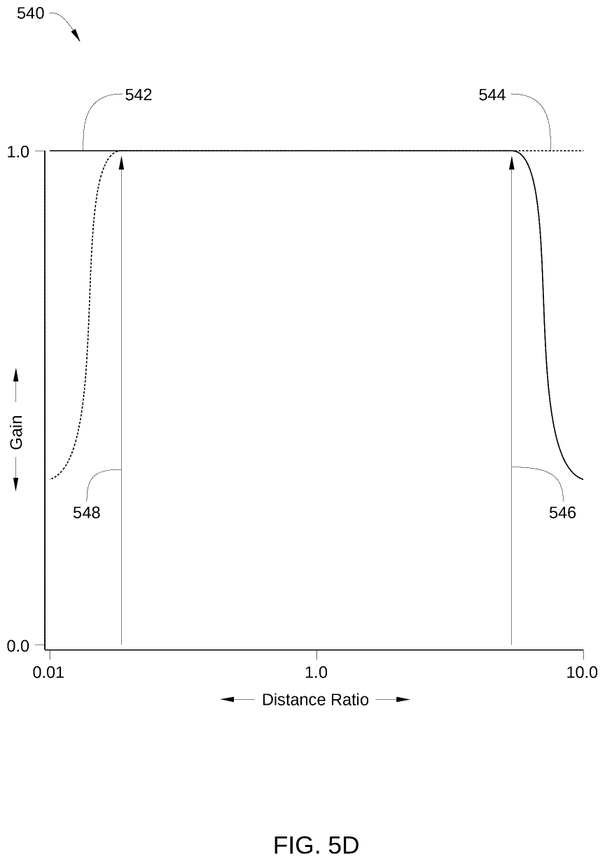

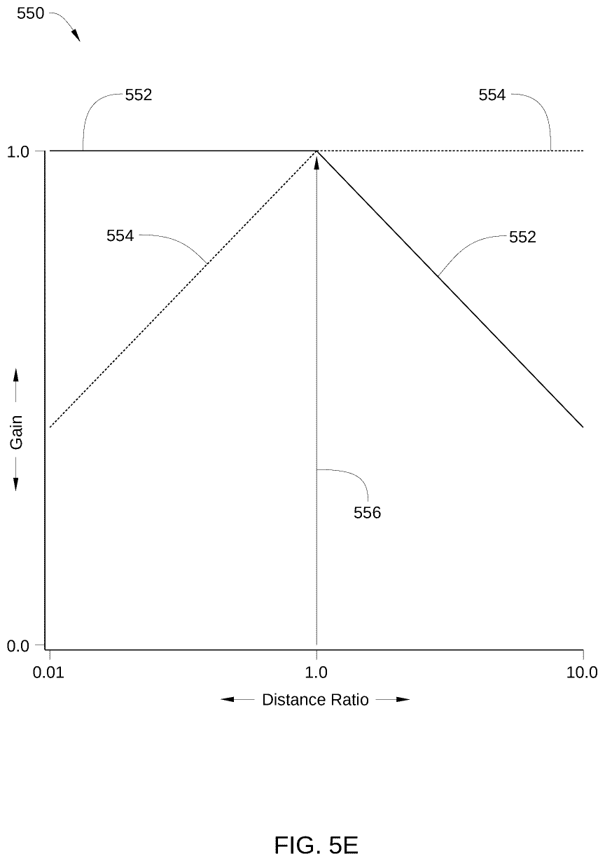

In the embodiment described in conjunction with FIG. 4, cross-fader curve 400 is implemented as two gain curves for the first speaker and the second speaker, respectively, that change linearly as a function of the distance ratio value of distance D1 and distance D2. In other embodiments, cross-fader curve 400 can be implemented as any other technically feasible set of gain curves for the first speaker and the second speaker. Example embodiments of such gain curves are described below in conjunction with FIGS. 5A-5E.

FIGS. 5A-5E illustrate various cross-fader curves for determining gain values, according to other various embodiments. FIG. 5A illustrates a cross-fader curve 510 that includes a first gain curve 512 and a second gain curve 514. As shown, in first gain curve 512 and second gain curve 514, gain values for the first speaker and the second speaker change as a function of the distance ratio value of distance D1 and distance D2, so that total sound power produced by the first speaker and the second speaker is constant.

FIG. 5B illustrates a cross-fader curve 520 that includes a first gain curve 522 and a second gain curve 524. As shown, in first gain curve 522 and second gain curve 524, gain values for the first speaker and the second speaker change as a function of the distance ratio value of distance D1 and distance D2 to create a slow fade effect. Thus, in the embodiment illustrated in FIG. 5B, gain values for the first speaker and the second speaker change so that a slow fade of sound produced by the first speaker occurs when the distance ratio value meets or exceeds a first value 526 and a slow fade of sound produced by the second speaker occurs when the distance ratio value falls below a second value 528.

FIG. 5C illustrates a cross-fader curve 530 that includes a first gain curve 532 and a second gain curve 534. As shown, in first gain curve 532 and second gain curve 534, gain values for the first speaker and the second speaker change as a function of the distance ratio value of distance D1 and distance D2 to create a slow cut effect. Thus, in the embodiment illustrated in FIG. 5C, gain values for the first speaker and the second speaker change so that a slow cut of sound produced by the first speaker occurs when the distance ratio value meets or exceeds a first value 536 and a slow cut of sound produced by the second speaker occurs when the distance ratio value falls below a second value 538.

FIG. 5D illustrates a cross-fader curve 540 that includes a first gain curve 542 and a second gain curve 544. As shown, in first gain curve 542 and second gain curve 544, gain values for the first speaker and the second speaker change as a function of the distance ratio value of distance D1 and distance D2 to create a fast cut effect. Thus, in the embodiment illustrated in FIG. 5D, gain values for the first speaker and the second speaker change so that a fast cut of sound produced by the first speaker occurs when the distance ratio value meets or exceeds a first value 546 and a fast cut of sound produced by the second speaker occurs when the distance ratio value falls below a second value 548.

FIG. 5E illustrates a cross-fader curve 550 that includes a first gain curve 552 and a second gain curve 554. As shown, in first gain curve 552 and second gain curve 554, gain values for the first speaker and the second speaker change as a function of the distance ratio value of distance D1 and distance D2 to create a transition effect. Thus, in the embodiment illustrated in FIG. 5E, gain values for the first speaker and the second speaker change so that a transition of sound produced by the first speaker to the sound produced by the second speaker occurs when the distance ratio value meets or exceeds a transition value 556 and a transition of sound produced by the second speaker occurs to the sound produced by first speaker 264 occurs when the distance ratio value falls below transition value 556.

In the above-described embodiments, determination of gain values for an audio system that include two speakers is described using a relatively simple panning algorithm that employs a cross-fader curve. In other embodiments, gain values can be determined for an audio system that includes an arbitrary number of speakers. In such embodiments, a surround-sound panning algorithm can be employed to describe suitable gain curve functions for each of the arbitrary number of speakers. The analytical expressions for surround-sound panning algorithms are easily derived from the cross-fader curves of FIGS. 4 and 5A-5E and can be implemented by one of skill in the art to implement such embodiments for determining gain values.

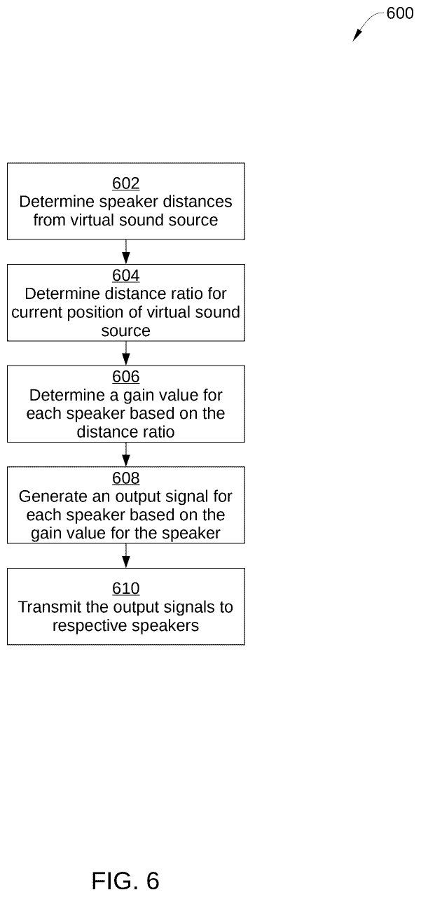

FIG. 6 is a flow diagram of method steps for producing a spatial audio scene, according to various embodiments. Although the method steps are shown in an order, persons skilled in the art will understand that some method steps may be performed in a different order, repeated, omitted, and/or performed by components other than those described in FIG. 6. Although the method steps are described with respect to the systems of FIGS. 1-5E, persons skilled in the art will understand that any system configured to perform the method steps, in any order, falls within the scope of the various embodiments.

As shown, a method 600 begins at step 602, where audio panning application 120 determines speaker distances from virtual sound source, such as distances D1, D2, and D3. Generally, a different distance is determined for each speaker of audio system 100. In some embodiments, one or more distance sensors 150 that are disposed within virtual sound source 102 are employed to determine distances D1, D2, and D3. Alternatively, in some embodiments, a different distance sensor disposed within each speaker of audio system 100 is employed to determine distances D1, D2, and D3.

At step 604, audio panning application 120 determines a distance ratio for the current location of virtual sound source 102. For example, in some embodiments, the distance ratio for the current location of virtual sound source 102 is a ratio of a first distance between one speaker of audio system 100 and virtual sound source 102 and a second distance between a second speaker of audio system 100 and virtual sound source 102.

At step 606, audio panning application 120 determines a gain value for each speaker of audio system 100. In embodiments in which audio system 100 includes two speakers, the gain value for each speaker can be determined based on the distance ratio determined in step 604. In embodiments in which audio system 100 includes three or more speakers, a more complex algorithm can be employed for determining gain values instead of using a distance ratio. For example, in such embodiments, a gain value for each speaker can be determined based on distances D1, D2, and D3 and a suitable surround-sound panning algorithm.

At step 608, audio panning application 120 generates an audio signal for each speaker based on the gain value for that speaker and on an input audio signal (e.g., input audio signal 210) that represents a sound associated with virtual sound source 102. Generally, the audio signal for a particular speaker is generated by modifying the input audio signal with the gain value associated with that particular speaker.

At step 610, audio panning application 120 transmits the audio output signal for each speaker to the respective speaker. In some embodiments, the audio output signals are transmitted wirelessly, and in other embodiments, the audio output signals are transmitted via Bluetooth, WiFi, or any other technically feasible wireless protocol.

In sum, techniques are disclosed for producing a spatial audio scene using proximity-base audio-object panning. In the embodiments, the spatial audio scene includes at least one virtual sound source, such as a toy or other object, that operates as a virtual sound source within the spatial audio scene. To produce the spatial audio scene, an audio signal representing the virtual sound source is generated by speakers of the audio system that are physically separate from the virtual sound source and therefore are not contained within the virtual sound source. In the embodiments, the audio signal generated by each speaker varies in volume based on a change in location of the virtual sound source relative to the speakers. In the embodiments, the spatial audio scene can be produced using proximity sensors that measure a distance from the virtual sound source to each speaker, where a gain value for each speaker is determined based on the measured distance from the virtual sound source to that speaker.

At least one technical advantage of the disclosed techniques relative to the prior art is that, with the disclosed techniques, a spatial audio scene can be created that includes a virtual sound source, such as a toy or other object for which an audio signal representing the virtual sound source is generated by speakers that are physically separate from the virtual sound source. With the disclosed techniques, the spatial audio scene can be produced using proximity sensors that measure the distance from the virtual sound source to each speaker that generates the audio signal representing the virtual sound source. As a result, the disclosed techniques can produce an immersive spatial audio mix with fewer hardware components and reduced software processing than other immersive spatial audio approaches. Another advantage of the disclosed techniques is that they are flexible with respect to various characteristics of the sound system producing a spatial audio scene, such as the number of speakers included in the sound system, the locations of the speakers within the listening area, and the number and location of virtual sound sources in the spatial audio scene. A further advantage of the disclosed techniques is that they readily implemented with real-time audio processing, which is important for immersive applications where audio needs to be processed and distributed quickly to maintain a certain audio experience.

Aspects of the disclosure are also described according to the following clauses.
1. In some embodiments, a computer-implemented method for generating sound for a virtual sound source includes: determining a first distance between a first speaker and a virtual sound source; determining a second distance between a second speaker and the virtual sound source; generating a first audio output signal for the first speaker based on an input audio signal, the first distance, and the second distance; generating a second audio output signal for the second speaker based on the input audio signal, the first distance, and the second distance; transmitting the first audio output signal to the first speaker for output; and transmitting the second audio output signal to the second speaker for output.
2. The computer-implemented method of clause 1, wherein generating the first audio output signal for the first speaker comprises determining a first gain value for the first speaker based on the first distance and the second distance.
3. The computer-implemented method of clauses 1 or 2, wherein generating the first audio output signal for the first speaker further comprises modifying the input audio signal with the first gain value to produce the first audio output signal.
4. The computer-implemented method of any of clauses 1-3, wherein determining the first gain value for the first speaker comprises: computing a distance ratio of the first distance and the second distance; and selecting the first gain value based on the distance ratio.
5. The computer-implemented method of any of clauses 1-4, wherein selecting the first gain value based on the distance ratio comprises selecting the first gain value from a cross-fader curve.
6. The computer-implemented method of any of clauses 1-5, wherein the cross-fader curve comprises one of a set of two gain curves that change linearly as a function of the distance ratio, a set of two gain curves that change as a function of the distance ratio so that total sound power produced by the first speaker and the second speaker is constant, a set of two gain curves that change as a function of the distance ratio to create a slow fade effect, a set of two gain curves that change as a function of the distance ratio to create a slow cut effect, a set of two gain curves that change as a function of the distance ratio to create a fast cut effect, or a set of two gain curves that change as a function of the distance ratio to create a transition effect.
7. The computer-implemented method of any of clauses 1-6, wherein generating the second audio output signal for the second speaker comprises determining a second gain value for the second speaker based on the first distance and the second distance
8. The computer-implemented method of any of clauses 1-7, further comprising: determining a third distance between the first speaker and the virtual sound source; determining a fourth distance between the second speaker and the virtual sound source; determining a third gain value for the first speaker based on the third distance and the fourth distance; and determining a fourth gain value for the second speaker based on the third distance and the fourth distance, wherein a sum of the squares of the first gain value and the second gain value equals a certain value and a sum of the squares of the third gain value and the fourth gain value equals the certain value.
9. The computer-implemented method of any of clauses 1-8, wherein determining the first gain value for the first speaker comprises: computing a distance ratio of the first distance and the second distance; and selecting the first gain value based on the distance ratio.
10. The computer-implemented method of any of clauses 1-9, wherein determining the first distance comprises receiving a distance from a distance sensor disposed within the virtual sound source.
11. The computer-implemented method of any of clauses 1-10, wherein determining the first distance comprises receiving a distance from a distance sensor disposed within the first speaker.
12. The computer-implemented method of any of clauses 1-11, wherein the virtual sound source comprises an interactive toy.
13. The computer-implemented method of any of clauses 1-12, wherein the input audio signal corresponds to the virtual sound source.
14. In some embodiments, one or more non-transitory computer-readable media store instructions that, when executed by one or more processors, cause the one or more processors to perform the steps of: determining a first distance between a first speaker and a virtual sound source; determining a second distance between a second speaker and the virtual sound source; generating a first audio output signal for the first speaker based on an input audio signal, the first distance, and the second distance; generating a second audio output signal for the second speaker based on the input audio signal, the first distance, and the second distance; transmitting the first audio output signal to the first speaker for output; and transmitting the second audio output signal to the second speaker for output.
15. The one or more non-transitory computer-readable media of clause 14, wherein generating the first audio output signal for the first speaker comprises determining a first gain value for the first speaker based on the first distance and the second distance.
16. The one or more non-transitory computer-readable media of clauses 14 or 15, wherein generating the first audio output signal for the first speaker further comprises modifying the input audio signal with the first gain value to produce the first audio output signal.
17. The one or more non-transitory computer-readable media of any of clauses 1-16, wherein determining the first gain value for the first speaker comprises: computing a distance ratio of the first distance and the second distance; and selecting the first gain value based on the distance ratio.
18. The one or more non-transitory computer-readable media of any of clauses 1-17, wherein generating the second audio output signal for the second speaker comprises determining a second gain value for the second speaker based on the first distance and the second distance.
19. The one or more non-transitory computer-readable media of any of clauses 1-18, wherein determining the first distance comprises receiving a distance from a distance sensor disposed within the first speaker.
20. In some embodiments, a system includes: a first speaker; a second speaker; one or more distance sensors operable to determine a first distance between a first speaker and a virtual sound source and a second distance between a second speaker and the virtual sound source; a memory storing instructions; and one or more processors, that when executing the instructions, are configured to perform the steps of: determining the first distance; determining the second distance; generating a first audio output signal for the first speaker based on an input audio signal, the first distance, and the second distance; generating a second audio output signal for the second speaker based on the input audio signal, the first distance, and the second distance; transmitting the first audio output signal to the first speaker for output; and transmitting the second audio output signal to the second speaker for output.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method, or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “module” or “system.” Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable processors or gate arrays.

The flowchart and block diagrams in the figures illustrate the architecture, functionality, and operation of possible implementations of systems, methods, and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure may be devised without departing from the basic scope thereof, and the scope thereof is determined by the claims that follow.

What is claimed is:

1. A computer-implemented method for generating sound for a virtual sound source, the computer-implemented method comprising:
determining a first distance between a first speaker and a virtual sound source;
determining a second distance between a second speaker and the virtual sound source;
generating a first audio output signal for the first speaker based on an input audio signal, the first distance, and the second distance;
generating a second audio output signal for the second speaker based on the input audio signal, the first distance, and the second distance;
transmitting the first audio output signal to the first speaker for output; and
transmitting the second audio output signal to the second speaker for output.

2. The computer-implemented method of claim 1, wherein generating the first audio output signal for the first speaker comprises determining a first gain value for the first speaker based on the first distance and the second distance.

3. The computer-implemented method of claim 2, wherein generating the first audio output signal for the first speaker further comprises modifying the input audio signal with the first gain value to produce the first audio output signal.

4. The computer-implemented method of claim 2, wherein determining the first gain value for the first speaker comprises:
computing a distance ratio of the first distance and the second distance; and
selecting the first gain value based on the distance ratio.

5. The computer-implemented method of claim 4, wherein selecting the first gain value based on the distance ratio comprises selecting the first gain value from a cross-fader curve.

6. The computer-implemented method of claim 5, wherein the cross-fader curve comprises one of a set of two gain curves that change linearly as a function of the distance ratio, a set of two gain curves that change as a function of the distance ratio so that total sound power produced by the first speaker and the second speaker is constant, a set of two gain curves that change as a function of the distance ratio to create a slow fade effect, a set of two gain curves that change as a function of the distance ratio to create a slow cut effect, a set of two gain curves that change as a function of the distance ratio to create a fast cut effect, or a set of two gain curves that change as a function of the distance ratio to create a transition effect.

7. The computer-implemented method of claim 2, wherein generating the second audio output signal for the second speaker comprises determining a second gain value for the second speaker based on the first distance and the second distance.

8. The computer-implemented method of claim 7, further comprising:
determining a third distance between the first speaker and the virtual sound source;
determining a fourth distance between the second speaker and the virtual sound source;
determining a third gain value for the first speaker based on the third distance and the fourth distance; and
determining a fourth gain value for the second speaker based on the third distance and the fourth distance,
wherein a sum of the squares of the first gain value and the second gain value equals a certain value and a sum of the squares of the third gain value and the fourth gain value equals the certain value.

9. The computer-implemented method of claim 7, wherein determining the first gain value for the first speaker comprises:
computing a distance ratio of the first distance and the second distance; and
selecting the first gain value based on the distance ratio.

10. The computer-implemented method of claim 1, wherein determining the first distance comprises receiving a distance from a distance sensor disposed within the virtual sound source.

11. The computer-implemented method of claim 1, wherein determining the first distance comprises receiving a distance from a distance sensor disposed within the first speaker.

12. The computer-implemented method of claim 1, wherein the virtual sound source comprises an interactive toy.

13. The computer-implemented method of claim 1, wherein the input audio signal corresponds to the virtual sound source.

14. One or more non-transitory computer-readable media storing instructions that, when executed by one or more processors, cause the one or more processors to perform the steps of:
determining a first distance between a first speaker and a virtual sound source;
determining a second distance between a second speaker and the virtual sound source;
generating a first audio output signal for the first speaker based on an input audio signal, the first distance, and the second distance;
generating a second audio output signal for the second speaker based on the input audio signal, the first distance, and the second distance;
transmitting the first audio output signal to the first speaker for output; and
transmitting the second audio output signal to the second speaker for output.

15. The one or more non-transitory computer-readable media of claim 14, wherein generating the first audio output signal for the first speaker comprises determining a first gain value for the first speaker based on the first distance and the second distance.

16. The one or more non-transitory computer-readable media of claim 15, wherein generating the first audio output signal for the first speaker further comprises modifying the input audio signal with the first gain value to produce the first audio output signal.

17. The one or more non-transitory computer-readable media of claim 15, wherein determining the first gain value for the first speaker comprises:
computing a distance ratio of the first distance and the second distance; and
selecting the first gain value based on the distance ratio.

18. The one or more non-transitory computer-readable media of claim 17, wherein generating the second audio output signal for the second speaker comprises determining a second gain value for the second speaker based on the first distance and the second distance.

19. The one or more non-transitory computer-readable media of claim 14, wherein determining the first distance comprises receiving a distance from a distance sensor disposed within the first speaker.

20. A system comprising:
a first speaker;
a second speaker;
one or more distance sensors operable to determine a first distance between a first speaker and a virtual sound source and a second distance between a second speaker and the virtual sound source;
a memory storing instructions; and
one or more processors, that when executing the instructions, are configured to perform the steps of:
determining the first distance;
determining the second distance;
generating a first audio output signal for the first speaker based on an input audio signal, the first distance, and the second distance;
generating a second audio output signal for the second speaker based on the input audio signal, the first distance, and the second distance;
transmitting the first audio output signal to the first speaker for output; and
transmitting the second audio output signal to the second speaker for output.
